(19) United States
(12) Patent Application Publication
(10) Pub. No.: US 2020/0342758 A1
(43) Pub. Date: Oct. 29, 2020

(54) DRIVE ASSISTANCE DEVICE, DRIVE ASSISTANCE METHOD, AND RECORDING MEDIUM IN WHICH DRIVE ASSISTANCE PROGRAM IS STORED

(71) Applicant: NEC COMMUNICATION SYSTEMS, LTD., Tokyo (JP)

(72) Inventors: Yuki BABA, Tokyo (JP); Akira MATSUMOTO, Tokyo (JP); Tetsuya ITO, Tokyo (JP); Chikashi ITO, Tokyo (JP)

(73) Assignee: NEC COMMUNICATION SYSTEMS, LTD., Tokyo (JP)

(21) Appl. No.: 16/955,919

(22) PCT Filed: Dec. 19, 2018
(86) PCT No.: PCT/JP2018/046832

§ 371 Date: Jun. 19, 2020

(30) Foreign Application Priority Data
Dec. 27, 2017 (JP) 2017-251494

(51) Int. Cl. G08G 1/16; G08G 1/09

(52) U.S. Cl. CPC G08G 1/161; G08G 1/09

(57) ABSTRACT

A drive assistance device includes: a collection unit that collects, from a sensor, own-vehicle-state-information representing a state related to a movement of an own vehicle and a position of the own vehicle; a communication unit that transmits the own-vehicle-state-information to another vehicle, and also receiving another-vehicle-state-information representing a state related to a movement of the another vehicle and a position of the another vehicle, from the another vehicle; a determination unit that determines whether a problem occurs in relation to the another vehicle, based on the another-vehicle-state-information being received; and a generation unit that generates, when the determination unit determines that the problem occurs in relation to the another vehicle, improvement operation information representing an operation of the own vehicle capable of improving the problem related to the another vehicle, based on the own-vehicle-state-information and the another-vehicle-state-information.

### TECHNICAL FIELD

The invention of the present application relates to a technique for assisting in driving by using information acquired by communicating with another vehicle moving around an own vehicle.

### BACKGROUND ART

A technique for controlling a vehicle such as an automobile, which is typified by a technique of automatic driving, has been rapidly progressing with progression of a technique such as artificial intelligence. As one of such techniques, there is a technique for assisting in driving by using information acquired by communicating with another vehicle located around an own vehicle by traveling around the own vehicle and the like. Such a technique can increase safety related to driving of a vehicle, and thus expectations on such a technique are rising.

As a technique related to such a technique, PTL 1 discloses a drive assistance system capable of transmitting and receiving information to and from each other between an own vehicle and another vehicle, and outputting drive assistance information that assists in driving to the own vehicle, based on information received from the another vehicle. When an own vehicle enters a lane different from a traveling lane of the own vehicle, the system outputs, to the own vehicle, drive assistance information representing that an entry into the different lane is permitted, based on traveling information representing a traveling state of another vehicle being received from the another vehicle in the different lane, and entry permission information representing that an entry is permitted.

Further, PTL 2 discloses a drive assistance system for causing a vehicle traveling around an abnormal vehicle to perform appropriate driving according to a state of the abnormal vehicle. The system detects an abnormal state related to a vehicle A, and transmits abnormal information related to the vehicle A in order to assist in driving of a vehicle B traveling around the vehicle A. The system assists in driving of the vehicle B, based on a traveling state related to the vehicle B and the abnormal information related to the vehicle A.

Further, PTL 3 discloses a device that performs a driving evaluation. The device acquires traveling information of a reference vehicle in a predetermined section on which a driving evaluation is performed. Then, the device simultaneously displays the same time-series traveling positions related to the reference vehicle and a vehicle to be evaluated, in a position indicating each of the traveling positions in a display region of a display means by using a vehicle model representing each of the vehicles, based on traveling information of the reference vehicle and traveling information of the vehicle to be evaluated.

### CITATION LIST

### Patent Literature

[PTL 1] Japanese Unexamined Patent Application Publication No. 2013-120945

[PTL 2] Japanese Unexamined Patent Application Publication No. 2007-293625

[PTL 3] Japanese Patent No. 4650028

### SUMMARY OF INVENTION

### Technical Problem

Various problems occur in a road traffic environment. FIG. 14A is a diagram exemplifying a situation where a problem occurs at an intersection where vehicles 501 to 505 pass. FIG. 14B is a diagram exemplifying a situation where the problem exemplified in FIG. 14A is solved. In the situation illustrated in FIG. 14A, the vehicles 501 to 504 stop due to a traffic jam and a red light, and the vehicle 505 is about to enter the intersection due to a green light. In this case, the vehicle 503 stops at the intersection in such a way as to block straight-ahead driving of the vehicle 505, and thus a problem that the vehicle 505 cannot enter the intersection even on the green light occurs. In other words, in the situation illustrated in FIG. 14A, a problem related to the vehicle 503 stopping at the intersection in such a way as to block straight-ahead driving of the vehicle 505 occurs. However, in this case, the vehicle 503 alone cannot solve the problem. As illustrated in FIG. 14B, the problem is solved by causing the vehicle 502 stopping with a long inter-vehicular distance from the vehicle 501 to move forward in such a way as to shorten the inter-vehicular distance from the vehicle 501, and then causing the vehicle 503 to exit from the intersection.

When a problem related to a vehicle in a road traffic environment occurs in such a manner, there are many cases where the problem is improved by performing an operation capable of improving (solving) the problem by another vehicle traveling around the vehicle. A general vehicle having a drive assistance function performs drive assistance on an own vehicle in such a way as to improve a problem occurring in the own vehicle, and does not thus perform drive assistance on the own vehicle in such a way as to improve a problem occurring in another vehicle as illustrated in FIGS. 14A and 14B. Further, for example, when a high-functionality sensor capable of acquiring a state of another vehicle is added to each vehicle or a sensor capable of monitoring a state of a plurality of vehicles is installed in a traffic infrastructure such as an intersection in such a way that drive assistance on an own vehicle can be performed for improving a problem occurring in another vehicle, there is a problem that a cost increases.

In other words, the present inventors have found that there is an issue of efficiently achieving that each vehicle performs drive assistance on an own vehicle for improving a problem occurring in another vehicle. There is no mention regarding such an issue in above-described PTLs 1 to 3. A main object of the invention of the present application is to provide a drive assistance device and the like that solve this problem.

### Solution to Problem

A drive assistance device according to one aspect of the invention of the present application includes: a collection means for collecting, from a sensor, own-vehicle-state-information representing a state related to a movement of an own vehicle and a position of the own vehicle; a communication means for transmitting the own-vehicle-state-information to another vehicle, and also receiving another-vehicle-state-information representing a state related to a movement of the another vehicle and a position of the another vehicle, from the another vehicle; a determination means for determining whether a problem occurs in relation to the another vehicle, based on the another-vehicle-state-information being received; and a generation means for generating, when the determination means determines that the problem occurs in relation to the another vehicle, improvement operation information representing an operation of the own vehicle capable of improving the problem related to the another vehicle, based on the own-vehicle-state-information and the another-vehicle-state-information.

From another standpoint of achieving the object described above, a drive assistance method according to one aspect of the invention of the present application includes: collecting, from a sensor, own-vehicle-state-information representing a state related to a movement of an own vehicle and a position of the own vehicle; transmitting the own-vehicle-state-information to another vehicle, and also receiving another-vehicle-state-information representing a state related to a movement of the another vehicle and a position of the another vehicle, from the another vehicle; determining whether a problem occurs in relation to the another vehicle, based on the another-vehicle-state-information being received; and generating, when determining that the problem occurs in relation to the another vehicle, improvement operation information representing an operation of the own vehicle capable of improving the problem related to the another vehicle, based on the own-vehicle-state-information and the another-vehicle-state-information.

Further, from yet another standpoint of achieving the object described above, a drive assistance program according to one aspect of the invention of the present application is a program for causing a computer to execute: collection processing of collecting, from a sensor, own-vehicle-state-information representing a state related to a movement of an own vehicle and a position of the own vehicle; communication processing of transmitting the own-vehicle-state-information to another vehicle, and also receiving another-vehicle-state-information representing a state related to a movement of the another vehicle and a position of the another vehicle, from the another vehicle; determination processing of determining whether a problem occurs in relation to the another vehicle, based on the another-vehicle-state-information being received; and generation processing of generating, when the determination processing determines that the problem occurs in relation to the another vehicle, improvement operation information representing an operation of the own vehicle capable of improving the problem related to the another vehicle, based on the own-vehicle-state-information and the another-vehicle-state information.

Further, the invention of the present application is also achievable by a computer-readable non-volatile recording medium in which the drive assistance program (computer program) is stored.

### Advantageous Effects of Invention

The invention of the present application is able to efficiently perform drive assistance for improving a problem occurring in relation to another vehicle.

### BRIEF DESCRIPTION OF DRAWINGS

FIG. 1 is a block diagram schematically illustrating a configuration of a drive assistance system 1 according to a first example embodiment of the invention of the present application.

FIG. 2 is a diagram schematically exemplifying a configuration of driving ability evaluation information 151 according to the first example embodiment of the invention of the present application.

FIG. 3 is a diagram schematically exemplifying a configuration of the driving ability evaluation information 151 generated by an evaluation unit 150 according to the first example embodiment of the invention of the present application being included in a vehicle 503 in a situation illustrated in FIG. 14A.

FIG. 4 is a diagram schematically exemplifying a configuration of the driving ability evaluation information 151 generated by the evaluation unit 150 according to the first example embodiment of the invention of the present application being included in a vehicle 502 in the situation illustrated in FIG. 14A.

FIG. 5 is a diagram schematically exemplifying a configuration of own vehicle-driving ability evaluation notification information 131 transmitted to the vehicle 502 and the like by a communication unit 120 according to the first example embodiment of the invention of the present application being included in the vehicle 503 in the situation illustrated in FIG. 14A.

FIG. 6 is a diagram schematically exemplifying a configuration of improvement operation information 141 generated by a generation unit 140 according to the first example embodiment of the invention of the present application being included in the vehicle 502 in the situation illustrated in FIG. 14A.

FIG. 7 is a diagram schematically exemplifying a configuration of the driving ability evaluation information 151 generated by the evaluation unit 150 according to the first example embodiment of the invention of the present application being included in a vehicle 512 in a situation illustrated in FIG. 15B.

FIG. 8 is a diagram schematically exemplifying a configuration of the own vehicle-driving ability evaluation notification information 131 transmitted to a vehicle 511 by the communication unit 120 according to the first example embodiment of the invention of the present application being included in the vehicle 512 in the situation illustrated in FIG. 15B.

FIG. 9 is a diagram schematically exemplifying a configuration of the driving ability evaluation information 151 generated by the evaluation unit 150 according to the first example embodiment of the invention of the present application being included in the vehicle 511 in the situation illustrated in FIG. 15B.

FIG. 10A is a flowchart (1/2) illustrating an operation of the drive assistance system 1 according to the first example embodiment of the invention of the present application.

FIG. 10B is a flowchart (2/2) illustrating an operation of the drive assistance system 1 according to the first example embodiment of the invention of the present application.

FIG. 11 is a flowchart illustrating an operation of generating the driving ability evaluation information 151 by the evaluation unit 150 according to the first example embodiment of the invention of the present application.

FIG. 12 is a block diagram schematically illustrating a configuration of a drive assistance device 300 according to a second example embodiment of the invention of the present application.

FIG. 13 is a block diagram illustrating a configuration of an information processing device 900 capable of executing a drive assistance device according to each of the example embodiments of the invention of the present application.

FIG. 14A is a diagram exemplifying a situation where a problem occurs at an intersection.

FIG. 14B is a diagram exemplifying a situation where the problem occurring at the intersection is solved.

FIG. 15A is a diagram exemplifying a situation before a problem occurs in relation to an inter-vehicular distance.

FIG. 15B is a diagram exemplifying a situation where the problem occurs in relation to the inter-vehicular distance.

### EXAMPLE EMBODIMENT

Hereinafter, example embodiments of the invention of the present application will be described in detail with reference to drawings.

### First Example Embodiment

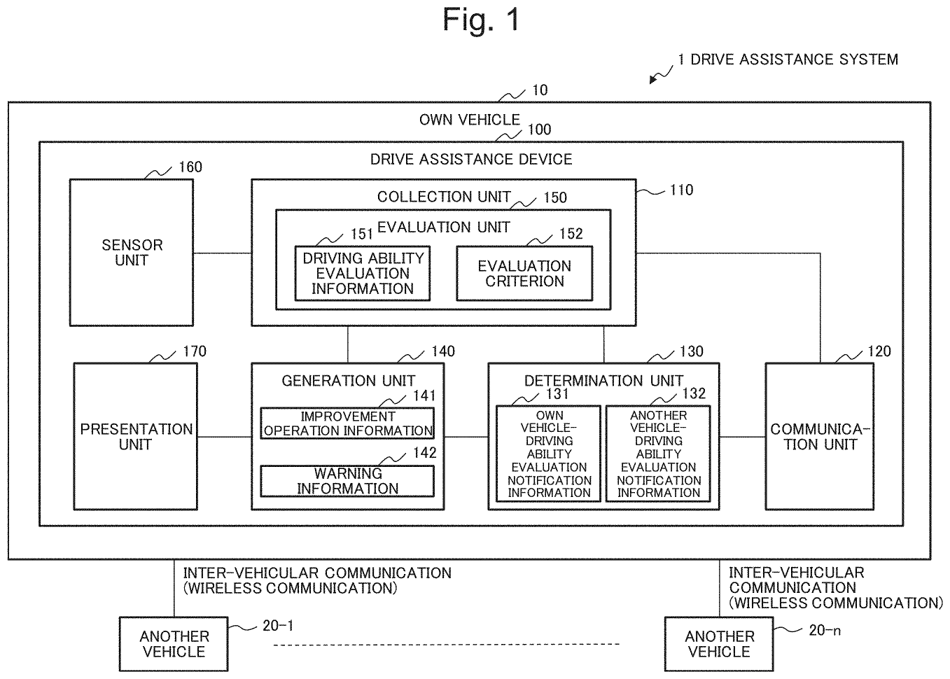

FIG. 1 is a block diagram schematically illustrating a configuration of a drive assistance system 1 according to a first example embodiment of the invention of the present application. In the drive assistance system 1, an own vehicle 10 and another vehicle 20-1 to another vehicle 20-n (n is any natural number) that move around the own vehicle 10 (that are located around the own vehicle 10 by traveling, stopping, or the like) perform drive assistance based on each other's states by performing inter-vehicular communication (wireless communication) with each other. However, in the present example embodiment, it is assumed that the another vehicle 20-1 to the another vehicle 20-n have a configuration similar to that of the own vehicle 10. Note that, hereinafter, at least any of the another vehicle 20-1 to the another vehicle 20-n may be simply referred to as the another vehicle 20 in the present application.

The own vehicle 10 includes a drive assistance device 100 that performs drive assistance on the own vehicle 10. The drive assistance device 100 is a device that presents information representing an appropriate driving operation to a driver while the driver is driving the own vehicle 10. Alternatively, when the own vehicle 10 has an automatic driving function, the drive assistance device 100 may input information representing an appropriate driving operation to a configuration that controls the automatic driving of the own vehicle 10.

The drive assistance device 100 includes a collection unit 110, a communication unit 120, a determination unit 130, a generation unit 140, a sensor unit 160, and a presentation unit 170.

The sensor unit 160 acquires information representing a state and an operation (behavior) of the own vehicle 10 and information (measurement data) representing a driving operation by the driver of the own vehicle 10. The sensor unit 160 includes a sensor capable of acquiring a position of the own vehicle 10 such as a global navigation satellite system (GNSS) sensor, for example. The sensor unit 160 may include, for example, a speed sensor that measures a speed at which the own vehicle 10 moves, an acceleration sensor that measures acceleration at which the own vehicle 10 moves, a sensor that measures an inter-vehicular distance between the own vehicle 10 and a vehicle in front of the own vehicle 10, and the like. The sensor unit 160 may further include, for example, a steering sensor that measures a steering wheel operation by the driver, a camera that monitors eye movements of the driver, and the like. The sensor unit 160 may further include, for example, a camera that captures the front, the rear, or the like of the own vehicle 10.

The collection unit 110 collects the measurement data acquired (measured) by the sensor unit 160 from the sensor unit 160.

The collection unit 110 according to the present example embodiment includes an evaluation unit 150. The evaluation unit 150 evaluates driving ability of the driver of the own vehicle 10 according to an evaluation criterion 152, based on the measurement data acquired from the sensor unit 160. Provided that the evaluation criterion 152 is assumed to be stored in a storage device such as a memory included in the drive assistance device 100. When performing the evaluation, the evaluation unit 150 can use the technique indicated in PTL 3, for example. The evaluation unit 150 generates driving ability evaluation information 151 representing an evaluation result related to driving ability of the driver of the own vehicle 10. The driving ability evaluation information 151 can be regarded as own-vehicle-state-information representing a state related to a movement of the own vehicle 10.

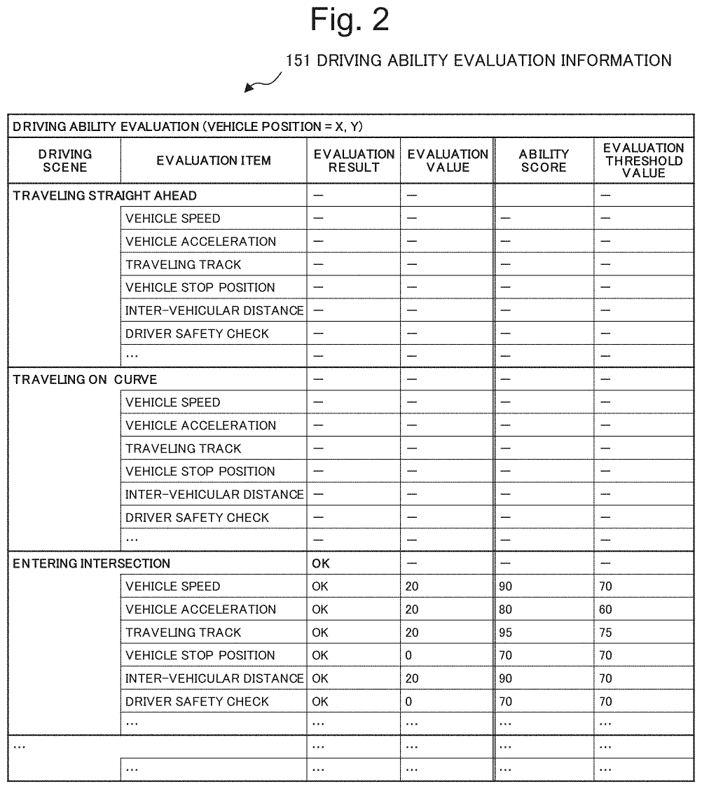

FIG. 2 is a diagram schematically exemplifying a configuration of the driving ability evaluation information 151 according to the present example embodiment. As illustrated in FIG. 2, the driving ability evaluation information 151 generated by the evaluation unit 150 is information in which each of values indicating “evaluation result”, “evaluation value”, “ability score”, and “evaluation threshold value” is associated with one or more evaluation items set for each driving scene.

The driving ability evaluation information 151 further includes positional information related to the own vehicle 10 acquired by the sensor unit 160. The driving ability evaluation information 151 exemplified in FIG. 2 indicates that the own vehicle 10 is located in coordinates of (X, Y) in a two-dimensional coordinate space. The coordinates of (X, Y) are values acquired based on the positional information (such as information including a longitude and a latitude) related to the own vehicle 10 acquired by a GNSS sensor, for example.

The evaluation unit 150 first determines a driving scene related to the own vehicle 10, based on the measurement data acquired from the sensor unit 160. In the example illustrated in FIG. 2, the evaluation unit 150 determines “entering intersection” as the driving scene. The evaluation unit 150 can determine “entering intersection” as the driving scene by an image analysis of a captured image acquired by a camera that captures the front of the own vehicle 10 included in the sensor unit 160, for example. Alternatively, the evaluation unit 150 can determine “entering intersection” as the driving scene by collating the positional information related to the own vehicle 10 with map information stored in a memory and the like included in the drive assistance device 100. Similarly, the evaluation unit 150 can also determine “traveling straight ahead”, or “traveling on curve”, or the like as the driving scene, based on the measurement data acquired from the sensor unit 160.

“Ability score” illustrated in FIG. 2 is a value acquired by scoring, by the evaluation unit 150, a value indicated by the measurement data acquired from the sensor unit 160, based on a procedure (using a predetermined calculation equation and the like, for example) indicated by the evaluation criterion 152. It is assumed that “ability score” is acquired by scoring a value indicated by the measurement data acquired from the sensor unit 160 in such a way as to have a higher score as the value is closer to an ideal value in driving, for example.

“Evaluation threshold value” illustrated in FIG. 2 is a threshold value used for determining whether a value indicated by “ability score” satisfies a criterion in which driving ability of the driver is expected, and is indicated by the evaluation criterion 152. The evaluation unit 150 calculates a difference between “ability score” and “evaluation threshold value” as “evaluation value” illustrated in FIG. 2. In the example illustrated in FIG. 2, since “ability score” is “90” and “evaluation threshold value” is “70” in relation to “vehicle speed”, for example, the evaluation unit 150 calculates “20” acquired by subtracting “70” from “90” as “evaluation value” related to “vehicle speed”.

The evaluation unit 150 determines that the criterion in which the driving ability of the driver is expected is satisfied in relation to an evaluation item having “evaluation value” equal to or greater than “0”, and determines that “evaluation result” of the evaluation item is “OK”. The evaluation unit 150 determines that the criterion in which the driving ability of the driver is expected is not satisfied in relation to an evaluation item having “evaluation value” less than “0”, and determines that “evaluation result” of the evaluation item is “BAD”. In the example illustrated in FIG. 2, “evaluation result” is “OK” in relation to all evaluation items set for the driving scene of “entering intersection”, and thus, in this case, the driving ability evaluation information 151 represents that no particular problem occurs in relation to a movement of the own vehicle 10 that enters an intersection.

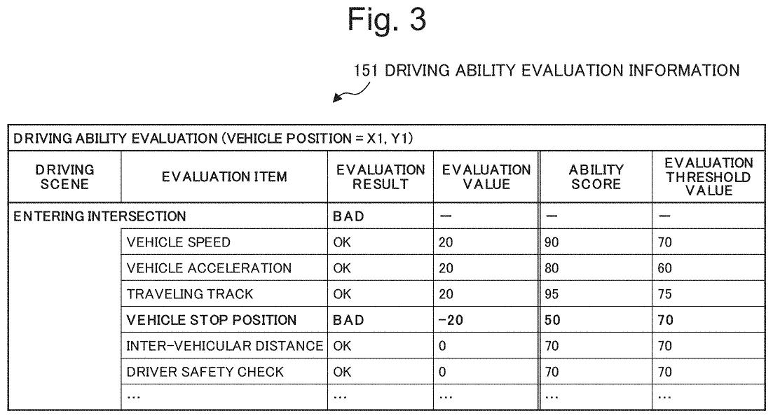

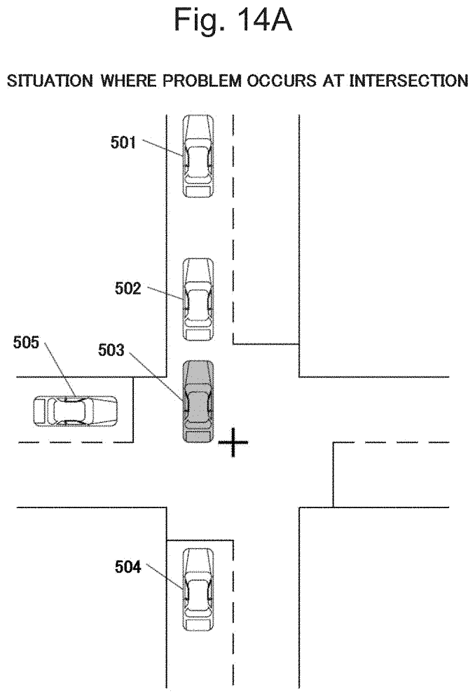

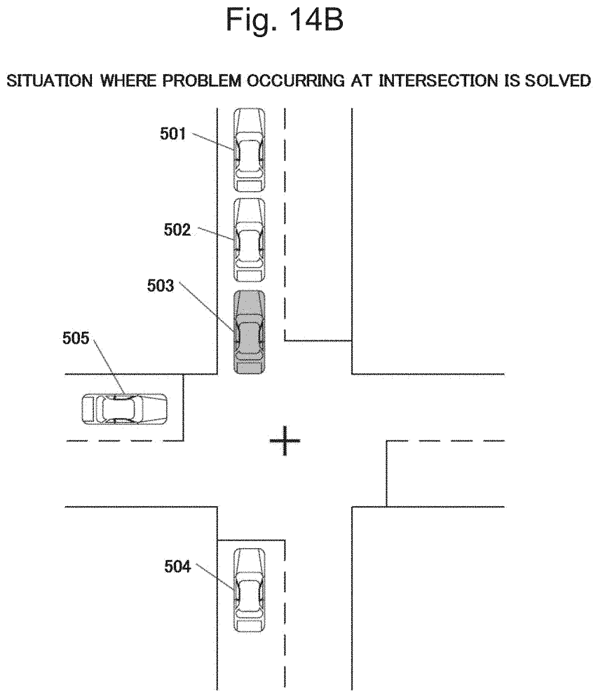

FIG. 3 is a diagram schematically exemplifying a configuration of the driving ability evaluation information 151 generated by the evaluation unit 150 according to the present example embodiment being included in the vehicle 503 in which a problem occurs in the situation illustrated in FIG. 14A described above. Provided that the vehicles 501 to 505 illustrated in FIGS. 14A and 14B are assumed to include the drive assistance device 100 according to the present example embodiment in the following descriptions.

In the example illustrated in FIG. 3, since the evaluation unit 150 of the vehicle 503 calculates “evaluation value” related to “vehicle stop position” as “−20”, the evaluation unit 150 determines that “evaluation result” related to “vehicle stop position” is “BAD”. In other words, in this case, the driving ability evaluation information 151 represents that a problem occurs in relation to a movement of the own vehicle 10 (the vehicle 503 illustrated in FIG. 14A) that enters the intersection. The driving ability evaluation information 151 exemplified in FIG. 3 also indicates that the vehicle 503 is located in coordinates of (X1, Y1) in the two-dimensional coordinate space.

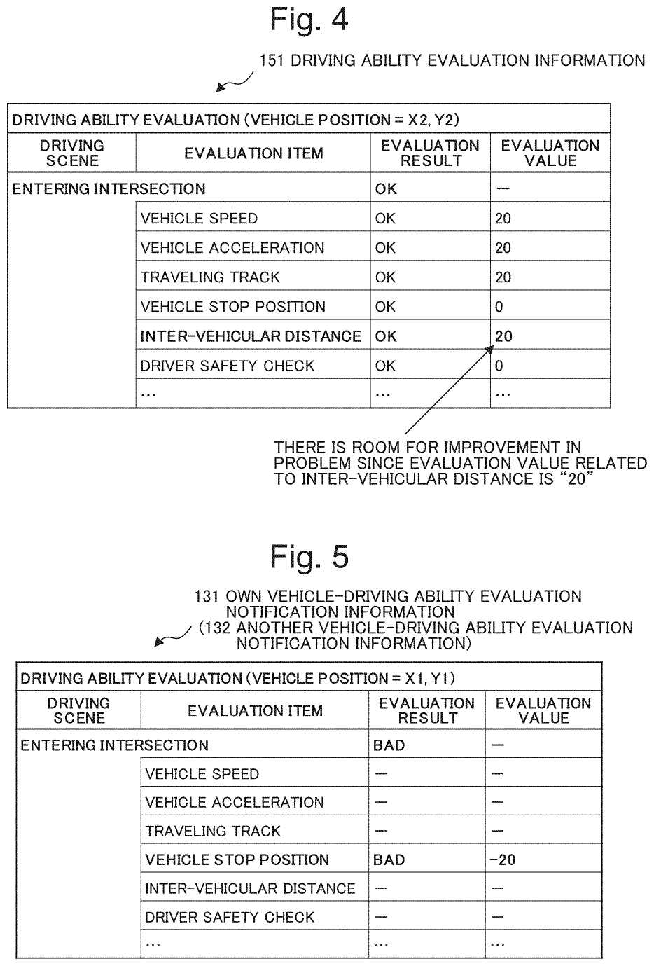

FIG. 4 is a diagram schematically exemplifying a configuration of the driving ability evaluation information 151 generated by the evaluation unit 150 according to the present example embodiment being included in the vehicle 502 moving in front of the vehicle 503 in which a problem occurs in the situation illustrated in FIG. 14A described above. However, portions related to “ability score” and “evaluation threshold value” included in the driving ability evaluation information 151 are omitted from FIG. 4.

In the example illustrated in FIG. 4, the evaluation unit 150 of the vehicle 502 calculates “evaluation value” related to “inter-vehicular distance” as “20”. The reason is that the vehicle 502 stops while securing a sufficient inter-vehicular distance from the vehicle 501 traveling in front of the vehicle 502 as illustrated in FIG. 14A. Then, in this case, the driving ability evaluation information 151 represents that no particular problem occurs in relation to a movement of the own vehicle 10 (the vehicle 502 illustrated in FIG. 14A). The driving ability evaluation information 151 exemplified in FIG. 4 also indicates that the vehicle 502 is located in coordinates of (X2, Y2) in the two-dimensional coordinate space.

When the driving ability evaluation information 151 generated by the evaluation unit 150 represents that a problem occurs in relation to a movement of the own vehicle 10, the communication unit 120 exemplified in FIG. 1 transmits the driving ability evaluation information 151 to the another vehicle 20 through the inter-vehicular communication. However, in the driving ability evaluation information 151, whether a problem occurs in relation to a movement of the own vehicle 10 is determined by the determination unit 130 described below. At this time, the communication unit 120 may generate own vehicle-driving ability evaluation notification information 131 by extracting the positional information related to the own vehicle 10 and a portion indicating the problem included in the driving ability evaluation information 151, and transmit the own vehicle-driving ability evaluation notification information 131 to the another vehicle 20.

FIG. 5 is a diagram schematically exemplifying a configuration of the own vehicle-driving ability evaluation notification information 131 transmitted to the vehicle 502 and the like by the communication unit 120 according to the present example embodiment being included in the vehicle 503 in the situation illustrated in FIG. 14A. Note that a configuration of another vehicle-driving ability evaluation notification information 132 described below is also similar to a configuration of the own vehicle-driving ability evaluation notification information 131. In the example illustrated in FIG. 5, the communication unit 120 generates the own vehicle-driving ability evaluation notification information 131 by extracting “evaluation result” and “evaluation value” related to “vehicle stop position” indicating that the problem occurs in relation to the movement of the own vehicle 10 (the vehicle 503 illustrated in FIG. 14A) in the driving ability evaluation information 151 exemplified in FIG. 3.

In the situation illustrated in FIG. 14A, the communication unit 120 of the vehicle 503 transmits the generated own vehicle-driving ability evaluation notification information 131 to the vehicle 501, the vehicle 502, the vehicle 504, and the vehicle 505 that move around the vehicle 503. Note that the another vehicle 20 being a target to which the own vehicle-driving ability evaluation notification information 131 is transmitted from the own vehicle 10 is, for example, a vehicle moving in a position equal to or less than a distance at which the inter-vehicular communication can be achieved from the own vehicle 10. In other words, in the situation illustrated in FIG. 14A, it is assumed that the vehicle 501, the vehicle 502, the vehicle 504, and the vehicle 505 are located in a position equal to or less than a distance at which the inter-vehicular communication can be achieved from the own vehicle 10 (the vehicle 503).

Further, the communication unit 120 exemplified in FIG. 1 receives, as the another vehicle-driving ability evaluation notification information 132, the own vehicle-driving ability evaluation notification information 131 related to the another vehicle 20 being transmitted by the communication unit 120 of the another vehicle 20. In other words, in the situation illustrated in FIG. 14A described above, the communication unit 120 of the vehicle 501, the vehicle 502, the vehicle 504, and the vehicle 505 receives, as the another vehicle-driving ability evaluation notification information 132, the own vehicle-driving ability evaluation notification information 131 transmitted by the communication unit 120 of the vehicle 503.

The determination unit 130 exemplified in FIG. 1 determines whether a problem occurs in relation to the another vehicle 20, based on the another vehicle-driving ability evaluation notification information 132 received from the another vehicle 20. For example, in the situation illustrated in FIG. 14A, the determination unit 130 of the vehicle 501, the vehicle 502, the vehicle 504, and the vehicle 505 determines that a problem occurs in relation to the vehicle 503, based on the another vehicle-driving ability evaluation notification information 132 exemplified in FIG. 5 being received from the vehicle 503.

When the determination unit 130 determines that the problem occurs in relation to the another vehicle 20, the generation unit 140 exemplified in FIG. 1 generates improvement operation information 141 representing an operation of the own vehicle 10 capable of improving the problem related to the another vehicle 20, based on the driving ability evaluation information 151 generated by the evaluation unit 150 of the own vehicle 10 and the another vehicle-driving ability evaluation notification information 132 received from the another vehicle 20.

For example, in the situation illustrated in FIG. 14A, the evaluation unit 150 of the vehicle 502 generates the driving ability evaluation information 151 exemplified in FIG. 4, and the communication unit 120 of the vehicle 502 receives the another vehicle-driving ability evaluation notification information 132 exemplified in FIG. 5 from the vehicle 503. In this case, the driving ability evaluation information 151 related to the vehicle 502 exemplified in FIG. 4 indicates that there is room for a score reduction of “20” in relation to “inter-vehicular distance” from the vehicle 501. Then, the another vehicle-driving ability evaluation notification information 132 related to the vehicle 503 exemplified in FIG. 5 indicates that there is a need for score improvement of “20” in relation to “vehicle stop position”. Provided that “1” related to “vehicle stop position” is assumed to correspond to, for example, a predetermined length (such as 0.1 meter, for example).

Further, the generation unit 140 of the vehicle 502 (the own vehicle 10) determines a relative positional relationship between the own vehicle 10 and the another vehicle 20, based on the positional information related to the vehicle 502 included in the driving ability evaluation information 151 and the positional information related to the vehicle 503 included in the another vehicle-driving ability evaluation notification information 132 received from the vehicle 503 (the another vehicle 20). In the situation illustrated in FIG. 14A, the generation unit 140 of the vehicle 502 determines, based on the positional relationship, that the vehicle 503 to which the another vehicle-driving ability evaluation notification information 132 is transmitted and in which the problem occurs is a vehicle following the vehicle 502.

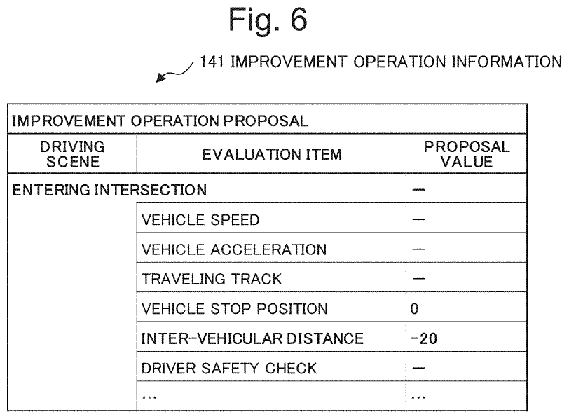

In this case, the generation unit 140 of the vehicle 502 predicts that “vehicle stop position” related to the vehicle 503 following the vehicle 502 can be improved by “20” by reducing “inter-vehicular distance” from the vehicle 501 by a distance corresponding to “20”, and the situation illustrated in FIG. 14A can be improved to the situation illustrated in FIG. 14B. Then, as exemplified in FIG. 6, the generation unit 140 of the vehicle 502 generates the improvement operation information 141 that proposes a reduction in “inter-vehicular distance” from the vehicle 501 by a distance corresponding to “20”. Provided that the generation unit 140 is assumed to be previously provided with information for predicting that a problem can be improved, based on the relative positional relationship between the own vehicle 10 and the another vehicle 20 in which the problem occurs and “evaluation value” for each evaluation item being represented by the driving ability evaluation information 151 and the another vehicle-driving ability evaluation notification information 132 received from the another vehicle 20.

The generation unit 140 inputs the generated improvement operation information 141 to the presentation unit 170 exemplified in FIG. 1. The presentation unit 170 is a device such as a monitor and a speaker, for example. The presentation unit 170 presents the improvement operation information 141 input from the generation unit 140 to the driver of the own vehicle 10 by a screen display, a voice, and the like, for example. For example, in the situation illustrated in FIG. 14A, the presentation unit 170 of the vehicle 502 presents an instruction that prompts a reduction in the inter-vehicular distance from the vehicle 501 stopping at the front to the driver of the vehicle 502 by a screen display, a voice, and the like.

The driver of the vehicle 502 performs a driving operation of reducing the inter-vehicular distance from the vehicle 501 according to the instruction presented from the presentation unit 170. Then, as the vehicle 502 moves forward, the driver of the vehicle 503 stopping at the intersection performs a driving operation of moving the vehicle 503 forward. In this way, the problem illustrated in FIG. 14A is solved as illustrated in FIG. 14B.

Next, an operation of the drive assistance system 1 according to the present example embodiment will be described in relation to a different case where a problem occurs between vehicles moving around each other.

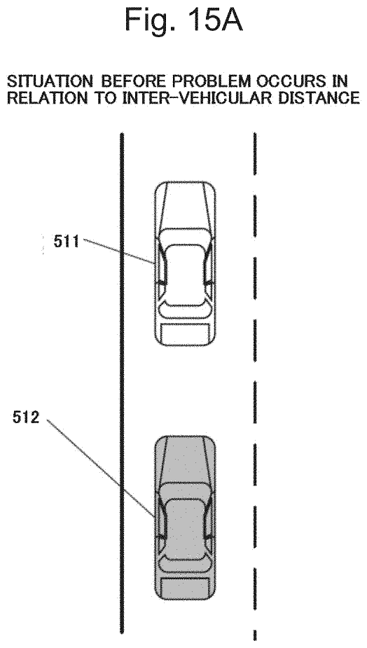

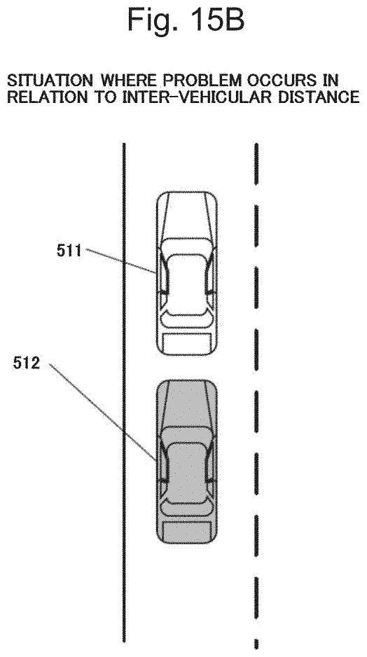

FIG. 15A is a diagram exemplifying a situation before a problem occurs in relation to an inter-vehicular distance between a vehicle 511 moving in a certain lane and a vehicle 512 following the vehicle 511. FIG. 15B is a diagram exemplifying a situation where the problem occurs in relation to the inter-vehicular distance being exemplified in FIG. 15A. Provided that the vehicles 511 and 512 illustrated in FIGS. 15A and 15B are assumed to include the drive assistance device 100 according to the present example embodiment in the following descriptions.

FIG. 15A represents the situation before the problem occurs in relation to the inter-vehicular distance, and the vehicle 512 moves while securing an appropriate inter-vehicular distance from the vehicle 511. FIG. 15B represents the situation where the problem occurs in relation to the inter-vehicular distance from the vehicle 511 due to inattentive driving by a driver of the vehicle 512 and the like, for example.

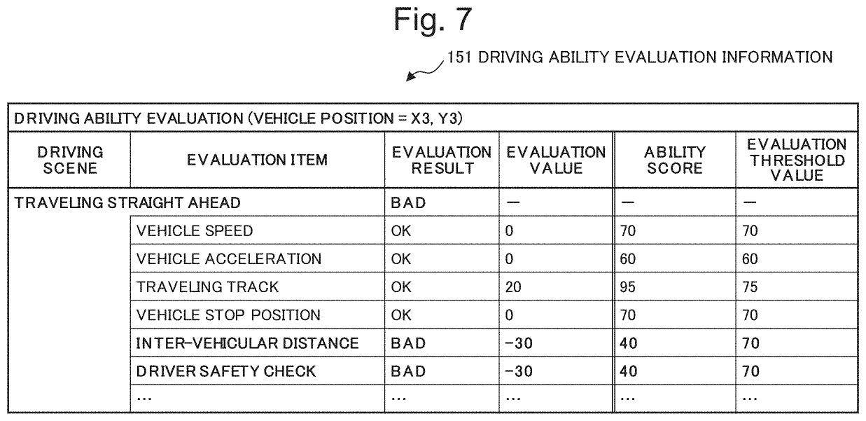

FIG. 7 is a diagram schematically exemplifying a configuration of the driving ability evaluation information 151 generated by the evaluation unit 150 according to the present example embodiment being included in the vehicle 512 in the situation illustrated in FIG. 15B. As illustrated in FIG. 7, the evaluation unit 150 of the vehicle 512 calculates evaluation values as “−30” in relation to “inter-vehicular distance” and “driver safety check”. In other words, in this case, since evaluation results related to “inter-vehicular distance” and “driver safety check” are “BAD”, the driving ability evaluation information 151 related to the vehicle 512 represents that a problem occurs in relation to a movement of the vehicle 512.

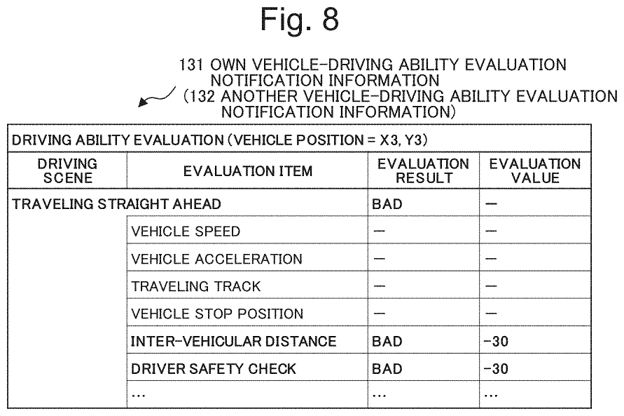

FIG. 8 is a diagram schematically exemplifying a configuration of the own vehicle-driving ability evaluation notification information 131 transmitted to the vehicle 511 by the communication unit 120 according to the present example embodiment being included in the vehicle 512 in the situation illustrated in FIG. 15B. In the example illustrated in FIG. 8, the communication unit 120 generates the own vehicle-driving ability evaluation notification information 131 by extracting “evaluation result” and “evaluation value” related to “inter-vehicular distance” and “driver safety check” indicating that the problem occurs in relation to the movement of the own vehicle 10 (the vehicle 512 illustrated in FIG. 15B) in the driving ability evaluation information 151 exemplified in FIG. 7.

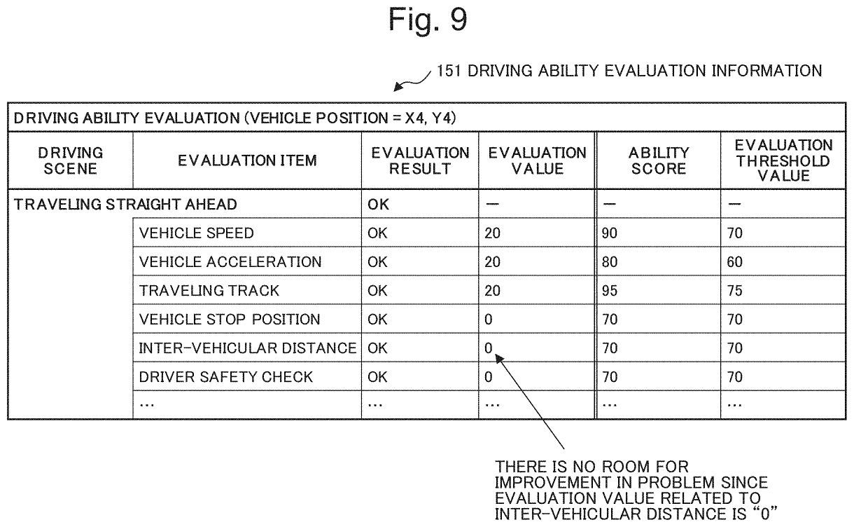

FIG. 9 is a diagram schematically exemplifying a configuration of the driving ability evaluation information 151 generated by the evaluation unit 150 according to the present example embodiment being included in the vehicle 511 in the situation illustrated in FIG. 15B. The driving ability evaluation information 151 exemplified in FIG. 9 indicates that an evaluation value related to “inter-vehicular distance” between the vehicle 511 and a vehicle (not illustrated in FIGS. 15A and 15B) moving just in front of the vehicle 511 is “0”. In other words, the driving ability evaluation information 151 related to the vehicle 511 represents that there is no room for improvement of the problem occurring in the vehicle 512 by increasing a vehicle speed by the vehicle 511 in order to reduce the inter-vehicular distance between the vehicle 511 and the vehicle moving just in front of the vehicle 511.

In the case illustrated in FIGS. 15A and 15B, the generation unit 140 of the vehicle 511 cannot generate the improvement operation information 141 as in the case illustrated in FIGS. 14A and 14B, and thus generates warning information 142 indicating that danger of accident occurrence and the like increases. The presentation unit 170 of the vehicle 511 presents the warning information 142 input from the generation unit 140 to a driver of the own vehicle 10 (the vehicle 511) by a screen display, a voice, and the like, for example. For example, in the situation illustrated in FIG. 15B, the presentation unit 170 of the vehicle 511 presents the driver of the vehicle 511 that danger of a collision with the vehicle 511 by the vehicle 512 increases, by a screen display, a voice, and the like.

Further, the communication unit 120 of the vehicle 511 transmits the warning information 142 generated by the generation unit 140 to the vehicle 512. Then, the drive assistance device 100 of the vehicle 512 presents the warning information 142 received from the generation unit 511 to the driver of the vehicle 512 by a screen display, a voice, and the like, for example.

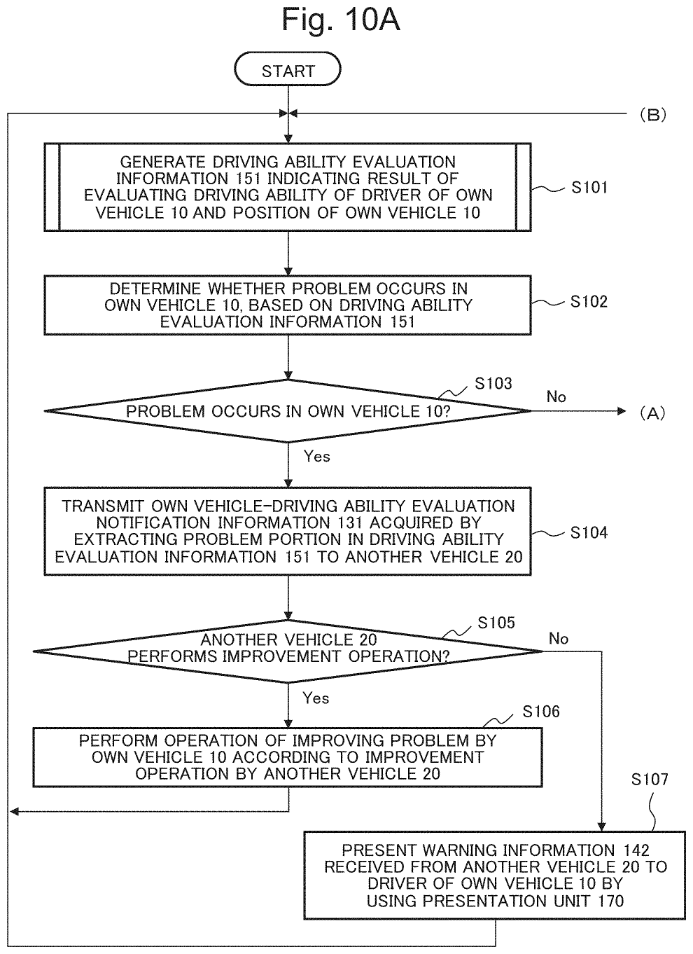

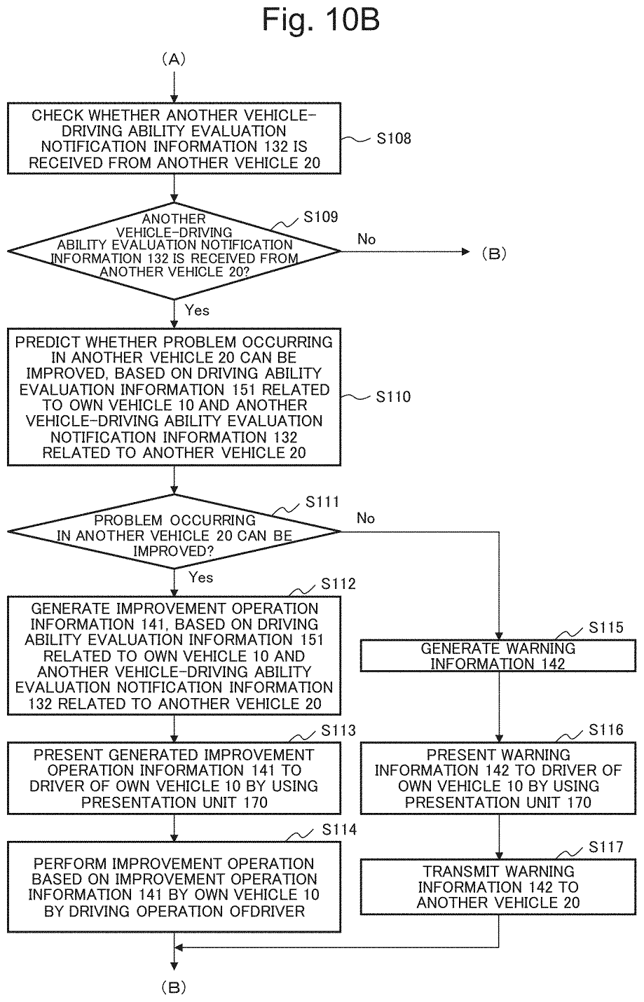

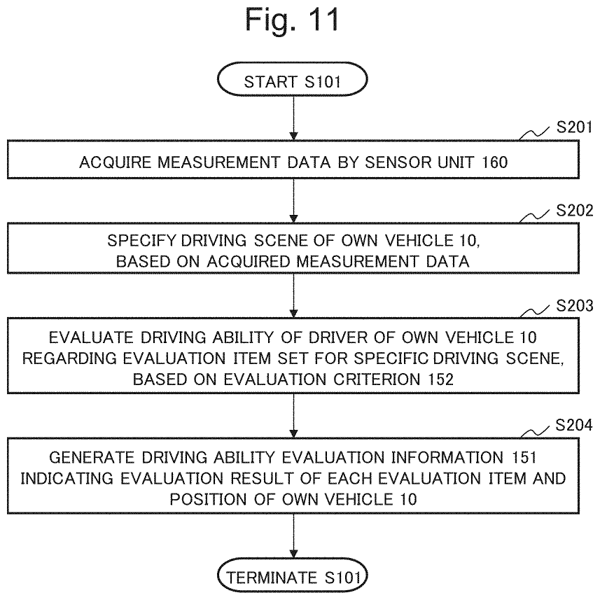

Next, an operation (processing) of the drive assistance system 1 according to the present example embodiment will be described in detail with reference to flowcharts in FIGS. 10A, 10B, and 11.

The evaluation unit 150 generates the driving ability evaluation information 151 indicating a result of evaluating driving ability of the driver of the own vehicle 10 and a position of the own vehicle 10 (step S101).

Herein, details of step S101 will be described with reference to FIG. 11. The evaluation unit 150 acquires measurement data by the sensor unit 160 (step S201). The evaluation unit 150 determines a driving scene of the own vehicle 10, based on the acquired measurement data (step S202). The evaluation unit 150 evaluates driving ability of the driver of the own vehicle 10 regarding an evaluation item set for the determined driving scene, based on the evaluation criterion 152 (step S203). The evaluation unit 150 generates the driving ability evaluation information 151 indicating the evaluation result of each evaluation item and a position of the own vehicle 10 (step S204), and step S101 terminates.

As illustrated in FIG. 10A, the determination unit 130 determines whether a problem occurs in the own vehicle 10, based on the driving ability evaluation information 151 generated by the evaluation unit 150 (step S102). When the problem does not occur in the own vehicle 10 (No in step S103), the processing proceeds to step S108.

When the problem occurs in the own vehicle 10 (Yes in step S103), the communication unit 120 transmits the own vehicle-driving ability evaluation notification information 131 acquired by extracting a portion of the problem in the driving ability evaluation information 151 to the another vehicle 20 (step S104).

When the another vehicle 20 that receives the own vehicle-driving ability evaluation notification information 131 as the another vehicle-driving ability evaluation notification information 132 from the own vehicle 10 performs an improvement operation capable of improving the problem occurring in the own vehicle 10 (Yes in step S105), the own vehicle 10 performs an operation of improving the problem by a driving operation of the driver of the own vehicle 10 according to the improvement operation by the another vehicle 20 (step S106), and the processing returns to step S101.

When the another vehicle 20 that receives the another vehicle-driving ability evaluation notification information 132 from the own vehicle 10 does not perform the improvement operation capable of improving the problem occurring in the own vehicle 10 (No in step S105), the drive assistance device 100 presents the warning information 142 received from the another vehicle 20 to the driver of the own vehicle 10 by using the presentation unit 170 (step S107), and the processing returns to step S101.

The determination unit 130 checks whether the another vehicle-driving ability evaluation notification information 132 is received from the another vehicle 20 (that is, whether the problem occurs in the another vehicle 20) (step S108). When the another vehicle-driving ability evaluation notification information 132 is not received from the another vehicle 20 (No in step S109), the processing returns to step S101.

When the another vehicle-driving ability evaluation notification information 132 is received from the another vehicle 20 (Yes in step S109), the generation unit 140 predicts whether the problem occurring in the another vehicle 20 can be improved, based on the driving ability evaluation information 151 related to the own vehicle 10 and the another vehicle-driving ability evaluation notification information 132 related to the another vehicle 20 (step S110).

When the problem occurring in the another vehicle 20 can be improved (Yes in step S111), the generation unit 140 generates the improvement operation information 141, based on the driving ability evaluation information 151 related to the own vehicle 10 and the another vehicle-driving ability evaluation notification information 132 related to the another vehicle 20 (step S112). The generation unit 140 presents the generated improvement operation information 141 to the driver of the own vehicle 10 by using the presentation unit 170 (step S113). The own vehicle 10 performs the improvement operation based on the improvement operation information 141 by the driving operation by the driver (step S114), and the processing returns to step S101.

When the problem occurring in the another vehicle 20 cannot be improved (No in step S111), the generation unit 140 generates the warning information 142 indicating that danger of accident occurrence and the like increase (step S115). The generation unit 140 presents the generated warning information 142 to the driver of the own vehicle 10 by using the presentation unit 170 (step S116). The communication unit 120 transmits the warning information 142 generated by the generation unit 140 to the another vehicle 20 (step S117), and the processing returns to step S101.

The drive assistance device 100 according to the present example embodiment can efficiently perform drive assistance in such a way as to improve a problem occurring in relation to another vehicle. The reason is that the drive assistance device 100 generates the improvement operation information 141 representing an operation of the own vehicle 10 capable of improving a problem related to the another vehicle 20, based on the driving ability evaluation information 151 (own-vehicle-state-information) representing a state related to a movement of the own vehicle 10 and a position of the own vehicle 10 and the another vehicle-driving ability evaluation notification information 132 (another-vehicle-state-information) representing a state related to a movement of the another vehicle 20 and a position of the another vehicle 20, which is received from the another vehicle 20.

An effect achieved by the drive assistance device 100 according to the present example embodiment will be described below in detail.

For example, as exemplified in FIGS. 14A and 14B, when a problem related to a vehicle in a road traffic environment occurs, there are many cases where the problem is improved by performing an operation capable of improving (solving) the problem by another vehicle moving around the vehicle. A general vehicle having a drive assistance function performs drive assistance on an own vehicle in such a way as to improve a problem occurring in the own vehicle, and does not thus perform drive assistance on the own vehicle in such a way as to improve a problem occurring in another vehicle as illustrated in FIGS. 14A and 14B. Further, for example, when a high-functionality sensor capable of acquiring a state of another vehicle is added to each vehicle or a sensor capable of monitoring a state of a plurality of vehicles is installed in a traffic infrastructure such as an intersection in such a way that drive assistance for an own vehicle can be performed in such a way as to improve a problem occurring in another vehicle, there is a problem that a cost increases. In other words, there is an issue of efficiently achieving that each vehicle performs drive assistance on an own vehicle in such a way as to improve a problem occurring in another vehicle.

For such an issue, the drive assistance device 100 according to the present example embodiment includes the collection unit 110, the communication unit 120, the determination unit 130, and the generation unit 140, and operates as described above with reference to FIGS. 1 to 11, for example. In other words, the collection unit 110 collects the driving ability evaluation information 151 (own-vehicle-state-information) representing a state related to a movement of the own vehicle 10 and a position of the own vehicle 10 from the sensor unit 160. The communication unit 120 transmits the own vehicle-driving ability evaluation notification information 131 to the another vehicle 20, and also receives the another vehicle-driving ability evaluation notification information 132 (another-vehicle-state-information) representing a state related to a movement of the another vehicle 20 and a position of the another vehicle 20 from the another vehicle 20. The determination unit 130 determines whether a problem occurs in relation to the another vehicle 20, based on the received another vehicle-driving ability evaluation notification information 132. When the determination unit 130 determines that the problem occurs in relation to the another vehicle 20, the generation unit 140 generates the improvement operation information 141 representing an operation of the own vehicle 10 capable of improving the problem related to the another vehicle 20, based on the own-vehicle-state-information and the another-vehicle-state-information.

In other words, the drive assistance device 100 according to the present example embodiment predicts an operation capable of improving (solving) the problem by using the information representing a state and a position of the another vehicle 20, which is received from the another vehicle 20 in which the problem occurs, and the information representing a state and a position of the own vehicle 10. The drive assistance device 100 does not need a high-functionality sensor and the like, capable of acquiring a state of another vehicle in order to perform this prediction. Therefore, the drive assistance device 100 according to the present example embodiment can efficiently perform drive assistance in such a way as to improve a problem occurring in relation to another vehicle.

Further, the drive assistance device 100 according to the present example embodiment includes the evaluation unit 150, and uses, as the own-vehicle-state-information, the driving ability evaluation information 151 representing a result of evaluating driving ability of the driver of the own vehicle 10 by the evaluation unit 150. Then, the another vehicle-driving ability evaluation notification information 132 received by the drive assistance device 100 from the another vehicle 20 is also information representing a result of evaluating driving ability of the driver of the another vehicle 20 by the evaluation unit 150 included in the another vehicle 20. Since an existing driving ability evaluation technique evaluates driving ability of a driver in detail, an evaluation result thereof can be regarded as information representing a state related to a movement of a vehicle with high accuracy. In other words, since the drive assistance device 100 according to the present example embodiment does not need development of a new configuration for generating information (own-vehicle-state-information) representing a state related to a movement of a vehicle by using the existing driving ability evaluation technique, the drive assistance device 100 can efficiently and accurately perform drive assistance in such a way as to improve a problem occurring in relation to another vehicle.

Note that the drive assistance device 100 according to the present example embodiment may generate the own-vehicle-state-information, based on measurement data acquired from the sensor unit 160, instead of using an evaluation result related to driving ability of a driver.

Further, the communication unit 120 according to the present example embodiment transmits the own-vehicle-state-information to the another vehicle 20 only when the determination unit 130 determines that a problem occurs in the own vehicle 10. Therefore, the drive assistance device 100 according to the present example embodiment can avoid an increase in communication data amount related to the inter-vehicular communication with the another vehicle 20. Note that the communication unit 120 may transmit the own-vehicle-state-information to the another vehicle 20 regardless of a result of determining whether a problem occurs in the own vehicle 10 by the determination unit 130.

Further, when a problem occurring in the another vehicle 20 cannot be improved by an operation of the own vehicle 10, the generation unit 140 according to the present example embodiment generates the warning information 142, and presents the generated warning information 142 to the driver of the own vehicle 10 by a screen display, a voice, and the like via the presentation unit 170. Then, in this case, the communication unit 120 according to the present example embodiment transmits the warning information 142 to the another vehicle 20. In this way, when the problem cannot be improved, the drive assistance device 100 according to the present example embodiment can increase safety by warning the drivers of the own vehicle 10 and the another vehicle 20 (by calling the drivers' attention).

Further, when the own vehicle 10 has an automatic driving function, the drive assistance device 100 according to the present example embodiment may input the generated improvement operation information 141 to a configuration that controls the automatic driving of the own vehicle 10. In other words, the own vehicle 10 can automatically perform an operation of improving a problem occurring in relation to the another vehicle 20.

the own vehicle 10 and the another vehicle 20 according to the present example embodiment are not limited to an automobile. The own vehicle 10 and the another vehicle 20 may be, for example, a robot having a movement function and the like.

### Second Example Embodiment

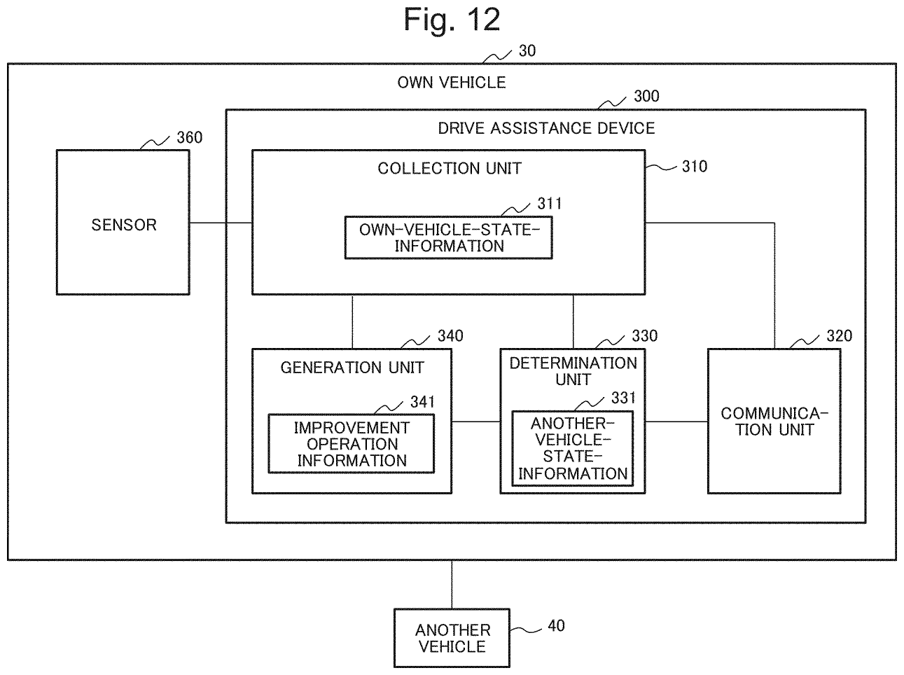

FIG. 12 is a block diagram schematically illustrating a configuration of a drive assistance device 300 according to a second example embodiment of the invention of the present application.

The drive assistance device 300 according to the present example embodiment includes a collection unit 310, a communication unit 320, a determination unit 330, and a generation unit 340. The drive assistance device 300 is a device that performs drive assistance on an own vehicle 30.

The collection unit 310 collects own-vehicle-state-information 311 representing a state related to a movement of the own vehicle 30 and a position of the own vehicle 30 from a sensor 360.

The communication unit 320 transmits the own-vehicle-state-information 311 to another vehicle 40, and also receives another-vehicle-state-information 331 representing a state related to a movement of the another vehicle 40 and a position of the another vehicle 40 from the another vehicle 40.

The determination unit 330 determines whether a problem occurs in relation to the another vehicle 40, based on the received another-vehicle-state-information 331.

When the determination unit 330 determines that the problem occurs in relation to the another vehicle 40, improvement operation information 341 representing an operation of the own vehicle 30 capable of improving the problem related to the another vehicle 40 is generated based on the own-vehicle-state-information 311 and the another-vehicle-state-information 331.

The drive assistance device 300 according to the present example embodiment can efficiently perform drive assistance in such a way as to improve a problem occurring in relation to another vehicle. The reason is that the drive assistance device 300 generates the improvement operation information 341 representing an operation of the own vehicle 30 capable of improving a problem on the another vehicle 40, based on the own-vehicle-state-information 311 representing a state related to a movement of the own vehicle 30 and a position of the own vehicle 30 and the another-vehicle-state-information 331 representing a state related to a movement of the another vehicle 40 and a position of the another vehicle 40, which is received from the another vehicle 40.

### Hardware Configuration Example

Each of the units in the drive assistance device illustrated in FIGS. 1 and 12 in each of the example embodiments described above can be achieved by dedicated hardware (HW) (electronic circuit). Further, in FIGS. 1 and 12, at least configurations described below can be regarded as functional (processing) units (software modules) of a software program.
Collection units 110 and 310,
Communication control function in communication units 120 and 320,
Determination units 130 and 330,
Generation units 140 and 340,
Evaluation unit 150.

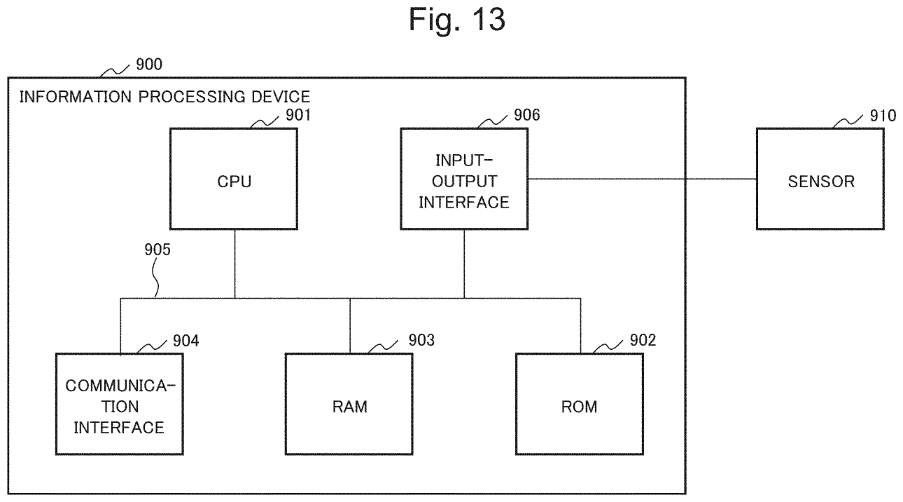

However, a division of each of the units illustrated in the drawings is a configuration for convenience in description, and various configurations can be devised for implementation. One example of a hardware environment in this case will be described with reference to FIG. 13.

FIG. 13 is a diagram exemplifying and describing a configuration of an information processing device 900 (computer) capable of executing the drive assistance device according to each of the example embodiments of the invention of the present application. In other words, FIG. 13 represents a configuration of a computer (information processing device) that can achieve the drive assistance device illustrated in FIGS. 1 and 12 and a hardware environment in which each of the functions in the example embodiments described above can be achieved.

The information processing device 900 illustrated in FIG. 13 includes the following as structural components.
A Central Processing Unit (CPU) 901,
A Read Only Memory (ROM) 902,
A Random Access Memory (RAM) 903,
A communication interface 904 with an external device,
A bus 905 (communication line),
An input-output interface 906 that controls an input and an output of a signal among a sensor 910, a monitor, a speaker, and the like.

In other words, the information processing device 900 including the structural components mentioned above is a general computer in which these configurations are connected to one another via the bus 905. The information processing device 900 may include a plurality of CPUs 901 and may include the CPU 901 constituted of a multi-core.

Then, the invention of the present application described by taking the above-described example embodiments as an example supplies a computer program capable of achieving the following functions to the information processing device 900 illustrated in FIG. 13. The functions are the above-described configurations in the block configuration diagrams (FIGS. 1 and 12) to which reference is made in the description of the example embodiments or the functions in the flowcharts (FIGS. 10A, 10B, and 11). The invention of the present application is then achieved by causing the CPU 901 of the hardware to read, interpret, and execute the computer program. Further, the computer program supplied in the device may be stored in a readable/writable volatile memory (RAM 903) or a non-volatile storage device such as the ROM 902.

In addition, a general procedure can be currently adopted as a method for supplying a computer program to the hardware in the above-mentioned case. Examples of the procedure include a method for installing a computer program in the device via various types of recording media and a method for downloading a computer program from outside via a communication line such as the Internet. Then, in such a case, it can be understood that the invention of the present application includes a code constituting the computer program or the recording medium in which the code is stored.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2017-251494, filed on Dec. 27, 2017, the disclosure of which is incorporated herein in its entirety by reference.

### REFERENCE SIGNS LIST

1 Drive assistance system
10 Own vehicle
100 Drive assistance device
110 Collection unit
120 Communication unit
130 Determination unit
131 Own vehicle-driving ability evaluation notification information
132 Another vehicle-driving ability evaluation notification information
140 Generation unit
141 Improvement operation information
142 Warning information
150 Evaluation unit
151 Driving ability evaluation information
152 Evaluation criterion
160 Sensor unit
170 Presentation unit
20-1 to 20-n Another vehicle
30 Own vehicle
300 Drive assistance device
310 Collection unit
311 Own-vehicle-state-information
320 Communication unit
330 Determination unit
331 Another-vehicle-state-information
340 Generation unit
341 Improvement operation information
360 Sensor
40 Another vehicle
501 to 505 Vehicle
511, 512 Vehicle
900 Information processing device
901 CPU
902 ROM
903 RAM
904 Communication interface
905 Bus
906 Input-output interface
910 Sensor

1. A drive assistance device, comprising:
at least one memory storing a computer program; and
at least one processor configured to execute the computer program to:
collect, from a sensor, own-vehicle-state-information representing a state related to a movement of an own vehicle and a position of the own vehicle;
transmit the own-vehicle-state-information to another vehicle, and also receive another-vehicle-state-information representing a state related to a movement of the another vehicle and a position of the another vehicle, from the another vehicle;
determine whether a problem occurs in relation to the another vehicle, based on the another-vehicle-state-information being received; and
generate, when determining that the problem occurs in relation to the another vehicle, improvement operation information representing an operation of the own vehicle capable of improving the problem related to the another vehicle, based on the own-vehicle-state-information and the another-vehicle-state-information.

2. The drive assistance device according to claim 1, wherein the processor is configured to execute the computer program to:
determine whether a problem occurs in relation to the own vehicle, based on the own-vehicle-state-information; and
transmit the own-vehicle-state-information to the another vehicle when determining that the problem occurs in relation to the own vehicle.

3. The drive assistance device according to claim 1, wherein the processor is configured to execute the computer program to:
generate information indicating a warning when the problem related to the another vehicle cannot be improved by an operation of the own vehicle; and
transmit the information indicating the warning to the another vehicle.

4. The drive assistance device according to claim 3, wherein the processor is configured to execute the computer program to
present the improvement operation information and the information indicating the warning being generated to a driver of the own vehicle.

5. The drive assistance device according to claim 1, wherein the processor is configured to execute the computer program to:
evaluate driving ability of a driver of the own vehicle, based on information acquired from the sensor, and generate the own-vehicle-state-information representing a result of the evaluating; and
receive the another-vehicle-state-information representing driving ability of a driver of the another vehicle.

6. The drive assistance device according to claim 5, wherein the processor is configured to execute the computer program to
determine a driving scene, based on the information acquired from the sensor, and evaluate the driving ability of the driver of the own vehicle for one or more evaluation items set for each of the driving scenes, based on a predetermined evaluation criterion.

7. The drive assistance device according to claim 6, wherein the processor is configured to execute the computer program to:
determine whether a value indicating the driving ability of the driver of the own vehicle satisfies a criterion for each of the evaluation items; and
determine that a problem occurs in relation to the own vehicle when the value indicating the driving ability of the driver of the own vehicle does not satisfy the criterion in relation to at least any of the evaluation items.

8. (canceled)

9. A drive assistance method, comprising,
by an information processing device:
collecting, from a sensor, own-vehicle-state-information representing a state related to a movement of an own vehicle and a position of the own vehicle;
transmitting the own-vehicle-state-information to another vehicle, and also receiving another-vehicle-state-information representing a state related to a movement of the another vehicle and a position of the another vehicle, from the another vehicle;
determining whether a problem occurs in relation to the another vehicle, based on the another-vehicle-state-information being received; and
generating, when determining that the problem occurs in relation to the another vehicle, improvement operation information representing an operation of the own vehicle capable of improving the problem related to the another vehicle, based on the own-vehicle-state-information and the another-vehicle-state-information.

10. A non-transitory computer-readable recording medium in which a drive assistance program is stored for causing a computer to execute:
collection processing of collecting, from a sensor, own-vehicle-state-information representing a state related to a movement of an own vehicle and a position of the own vehicle;
communication processing of transmitting the own-vehicle-state-information to another vehicle, and also receiving another-vehicle-state-information representing a state related to a movement of the another vehicle and a position of the another vehicle, from the another vehicle;
determination processing of determining whether a problem occurs in relation to the another vehicle, based on the another-vehicle-state-information being received; and
generation processing of generating, when the determination processing determines that the problem occurs in relation to the another vehicle, improvement operation information representing an operation of the own vehicle capable of improving the problem related to the another vehicle, based on the own-vehicle-state-information and the another-vehicle-state-information.
